(19) United States
(12) Patent Application Publication
(10) Pub. No.: US 2013/0314058 A1
(43) Pub. Date: Nov. 28, 2013

(54) VOLTAGE CONVERSION CIRCUIT

(71) Applicant: HON HAI PRECISION INDUSTRY CO., LTD., New Taipei (TW)

(72) Inventors: KAI-FU CHEN, New Taipei (TW); CHUANG-WEI TSENG, New Taipei (TW)

(73) Assignee: HON HAI PRECISION INDUSTRY CO., LTD., New Taipei (TW)

(21) Appl. No.: 13/890,296

(22) Filed: May 9, 2013

(30) Foreign Application Priority Data
May 28, 2012 (TW) 101118896

(51) Int. Cl. H02M 3/06

(52) U.S. Cl. CPC H02M 3/06
USPC 323/233

(57) ABSTRACT

A voltage conversion circuit includes a power source, at least one first capacitor, and a voltage convertor. The power source is for providing power for the voltage conversion circuit. The at least one first capacitors are electrically connected to the power source in parallel. The voltage convertor includes at least one group of first input pins, at least one group of second input pins, and at least one output pin that outputs converted voltage of the power to a load. The first and second group of input pins are respectively arranged on different edges of the voltage convertor, the power source and the at least one first capacitors are selectively electrically connected to one of the group of the first and second input pins and are arranged beside a corresponding edge of the voltage convertor.

### BACKGROUND

1. Technical Field

The present disclosure relates to a voltage conversion circuit.

2. Description of Related Art

Electronic apparatuses, such as a personal computer (PC) or a sever, need to combine a plurality of power conversion circuits to output different voltages, such as 12V, 5V, or 3.3V for example. Each power conversion circuit includes several electronic elements, such as power sources, capacitors, voltage convertors, and inductors, for example. The power conversion circuits occupy a large area of a mainboard of the electronic apparatus, which is disadvantage for miniaturization of the electronic apparatus. To decrease external size of the voltage convertors is desired, however, decreasing the external size of the voltage convertors is very limited, because when the external size of the voltage convertors is decreased, pins of the voltage convertor are difficult to solder and can be easily damaged, which easily affects signal transmission.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 illustrates a voltage conversion circuit of a preferred embodiment of the present disclosure.

FIG. 2 illustrates the voltage conversion circuit of FIG. 1 in another layout.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one”.

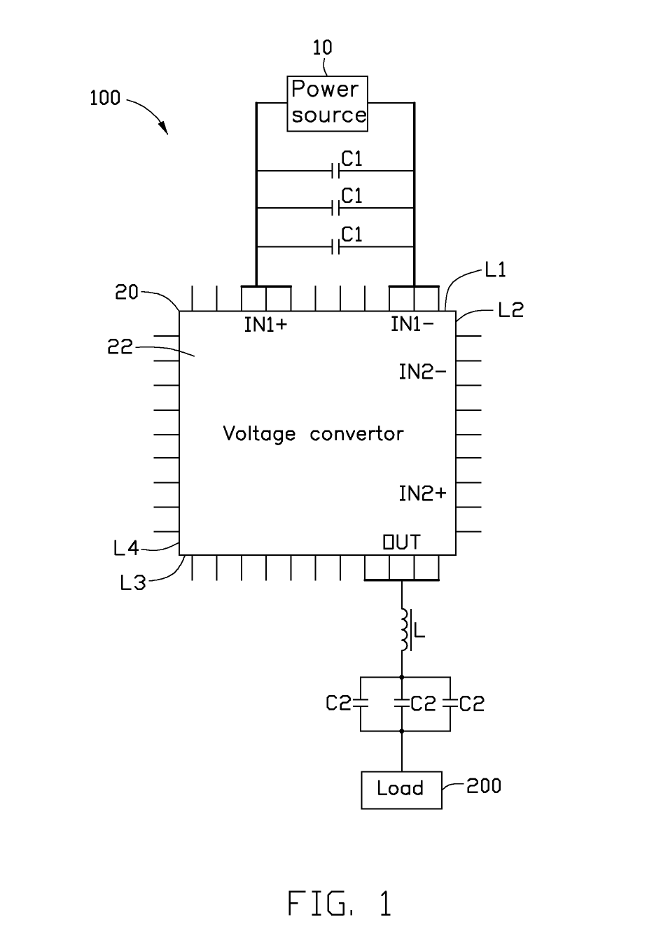

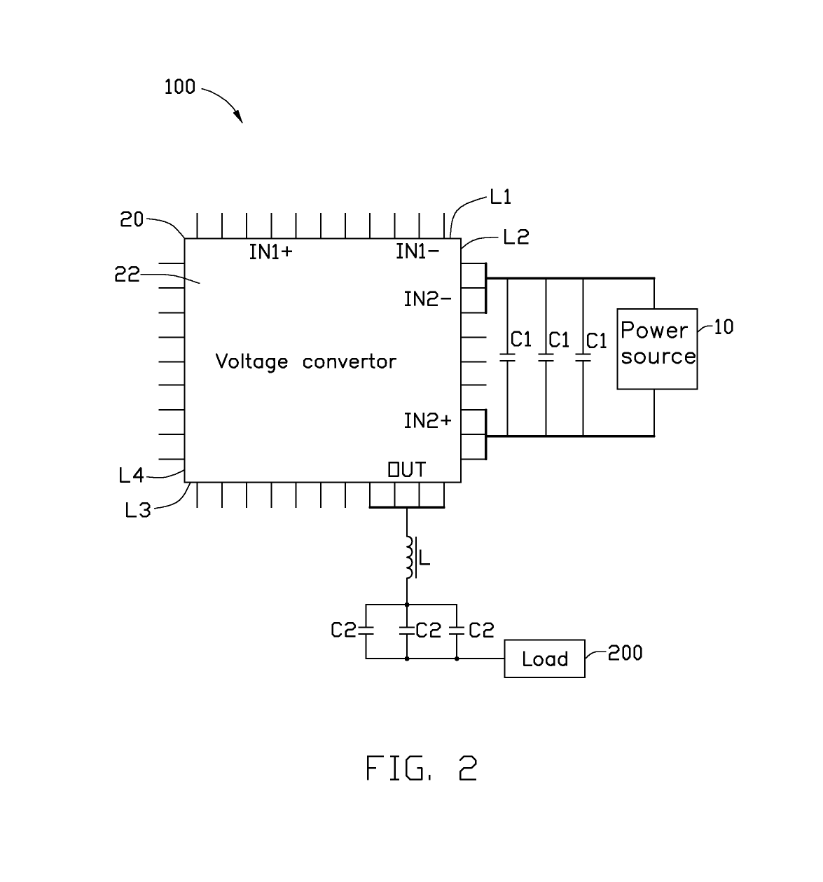

FIG. 1 illustrates a voltage conversion circuit 100 of a preferred embodiment of the present disclosure. FIG. 2 illustrates the voltage conversion circuit 100 of FIG. 1 in another layout. The voltage conversion circuit 100 supplies a working voltage (such as 12V, 5V, or 3.3V etc) to a load 200 (such as a central processing unit, CPU) of electronic apparatus, such as a personal computer (PC) or a server.

The voltage conversion circuit 100 includes a power source 10, a plurality of first capacitors C1, a voltage convertor 20, an inductor L, and a plurality of second capacitors C2.

The power source 10 is a direct current power source. In the present embodiment, the power source 10 outputs a 12V direct current.

The plurality of first capacitors C1 are electrically connected in parallel with the power source 10. The capacitors C1 stabilize an output voltage of the power source 10.

In the present embodiment, the voltage convertor 20 is a DC-DC convertor, converts the direct current output by the power source 10, and outputs a direct current with another voltage (such as 5V) required by the load 200. The voltage convertor 20 is packaged by ball grid array (BGA) technology and includes a chip carrier 22, a plurality of current input pins, a plurality of current output pins OUT, and a plurality of functional pins (not labeled). The plurality of current input pins are electrically connected to the power source 10 to get power. The plurality of current output pins OUT are electrically connected to the conductor L. The plurality of current input pins include a plurality of first positive pins IN1+, a plurality of first negative pins IN1−, a plurality of second negative pins IN2−, and a plurality of second positive pins IN2+.

The chip carrier 22 is rectangular in shape, and includes a first edge L1, a second edge L2, a third edge L3, and a fourth edge L4 connected in that order. In the present embodiment, the plurality of first positive pins IN1+ are arranged on a middle portion of the first edge L1. The plurality of first negative pins IN1− are arranged on an end of the first edge L1, near the second edge L2. The plurality of second negative pins IN2− are arranged on an end of the second edge L2, near the first edge L1. The plurality of second positive pins IN2+ are arranged on an end of the second edge L2, near the third edge L3. The plurality of current output pins OUT are arranged on an end of the third edge L3, near the second edge L2.

The conductor L is electrically connected to the plurality of current output pins OUT. The plurality of second capacitors C2 are electrically connected to each other in parallel, and are cooperatively electrically connected between the conductor L and the load 200 in series. The conductor L and the plurality of second capacitors C2 cooperatively form a LC filter circuit, which filters ripple voltages output by the voltage convertor 20.

Two ways of layout for the voltage conversion circuit 100 are described as follows:

FIG. 1 shows a first layout of the voltage conversion circuit 100. The plurality of first capacitors C1 are in parallel and are electrically connected between the plurality of first positive pins IN1+ and the plurality of first negative pins IN1−. The plurality of first positive pins IN1+ are shorted and the plurality of first negative pins IN1− are shorted to increase the width of cabling when welding, thus dissipating the heat caused by the current. In addition, the plurality of current output pins OUT are shorted and electrically connected to the load 200 via the conductor L and the plurality of second capacitors C2, thus the direct current converted by the voltage convertor 20 is supplied to the load 200. In the first layout, the plurality of first capacitors C1, the voltage convertor 20, the conductor L, and the plurality of second capacitors C2 are arranged from top to bottom orderly in orientation, which is suitable for the mainboard of the electronic apparatus providing an area having a longer length for arranging the voltage conversion circuit 100.

FIG. 2 shows a second layout of the voltage conversion circuit 100. The plurality of first capacitors C1 are in parallel and are electrically connected between the plurality of second positive pins IN2+ and the plurality of second negative pins IN2−.

The plurality of second positive pins IN2+ are shorted, and the plurality of second negative pins IN2− are shorted. In addition, the plurality of current output pins OUT are shorted and are electrically connected to the load 200 via the conductor L and the plurality of second capacitors C2. In the second layout, the plurality of first capacitors C1 and the voltage convertor 20 are arranged from right to left in orientation, the voltage convertor 20, the conductor L, and the plurality of second capacitors C2 are arranged from top to bottom, which is suitable for the motherboard providing an area with limited length for arranging the voltage conversion circuit 100.

In other embodiments, the position of the plurality of current input pins can be changed, for example, the plurality of second negative pins IN2− and the plurality of second positive pins IN2+ can be arranged on the third edge L3. Accordingly, the plurality of first capacitors C1 and the voltage convertor 20 are arranged from left to right.

In other embodiments, the quantity for each of the first positive pins IN1+, the first negative pins IN1−, the second negative pins IN2− and the second positive pins IN2+ can be one.

The voltage conversion circuit 100 increases the plurality of second negative pins IN2− and the plurality of second positive pins IN2+ on the voltage convertor 20, thus the voltage conversion circuit 100 has at least two layouts. The plurality of first capacitors C1 and the voltage convertor 20 are arranged from top to bottom via the plurality of first negative pins IN1− and the plurality of first positive pins IN1+, or the plurality of first capacitors C1 and the voltage convertor 20 are arranged from right to left via plurality of second negative pins IN2− and the plurality of second positive pins IN2+. Thus, the voltage conversion circuit 100 is available for the mainboard of the electronic apparatus with different size of area for arranging elements.

Even though numerous characteristics and advantages of the embodiments have been set forth in the foregoing description, together with details of the structure and function of the embodiments, the present disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. A voltage conversion circuit, comprising:
a power source providing power for the voltage conversion circuit;
at least one first capacitor electrically connected to the power source in parallel;
a voltage convertor, including at least one group of first input pins, at least one group of second input pins, and at least one output pin that outputs converted voltage of the power to a load;
wherein the first and second group of input pins are respectively arranged on different edges of the voltage convertor, the power source and the at least one first capacitors are selectively electrically connected to one of the group of the first and second input pins and are arranged beside a corresponding edge of the voltage convertor.

2. The voltage conversion circuit of claim 1, wherein the voltage convertor further comprises a chip carrier, the chip carrier comprises a first edge, a second edge, a third edge, and a fourth edge connected in that order.

3. The voltage conversion circuit of claim 2, wherein the group of first input pins include a plurality of first positive pins, a plurality of first negative pins, a plurality of second positive pins, and a plurality of second negative pins.

4. The voltage conversion circuit of claim 3, further comprising a conductor and at least one second capacitor, wherein the voltage convertor is electrically connected to the load via the conductor and the at least one second capacitor in series.

5. The voltage conversion circuit of claim 4, wherein the first positive pin and the first negative pin are arranged on the first edge, the second positive pin and the second negative pin are arranged on the second edge.

6. The voltage conversion circuit of claim 5, wherein the quantity of each first positive pin, first negative pin, second positive pin, second negative pin, and current output pin is a plurality.

7. The voltage conversion circuit of claim 4, wherein the current output pin is arranged on the third edge and electrically connected to the conductor.

8. The voltage conversion circuit of claim 3, wherein the plurality of the first positive pins are shorted, the plurality of the first negative pins are shorted, the plurality of the second positive pins are shorted, the plurality of the second negative pins are shorted, and the plurality of the output pins are shorted.

9. The voltage conversion circuit of claim 1, wherein the voltage conversion uses DC-DC conversion and is packaged by ball grid array technology.

10. A voltage conversion circuit, comprising:
a power source providing power for the voltage conversion circuit;
at least one first capacitor electrically connected to the power source in parallel;
a voltage convertor, including at least one group of first input pins, at least one group of second input pins, and at least one output pin that outputs a converted voltage of the power to a load; and
a LC filter circuit;
wherein the voltage convertor is electrically connected to the load via the LC filter circuit; the first capacitor and the voltage conversion are arranged in a up-down direction according to the first capacitor electrically connected between the group of first input pins, or are arranged in a left-right direction according to the first capacitor electrically connected between the group of second input pins.

11. The voltage conversion circuit of claim 10, wherein the voltage convertor further comprises a chip carrier, the chip carrier comprises a first edge, a second edge, a third edge, and a fourth edge connected in that order.

12. The voltage conversion circuit of claim 11, wherein the group of first input pins include a plurality of first positive pins, a plurality of first negative pins, a plurality of second positive pins, and a plurality of second negative pins.

13. The voltage conversion circuit of claim 12, wherein the LC filter circuit includes a conductor and at least one second capacitor, the voltage convertor is electrically connected to the load via the conductor and the at least one second capacitor in series.

14. The voltage conversion circuit of claim 13, wherein the first positive pin and the first negative pin are arranged on the first edge, the second positive pin and the second negative pin are arranged on the second edge.

15. The voltage conversion circuit of claim 14, wherein the at least one current output pin arranged on the third edge and electrically connected to the conductor.

16. The voltage conversion circuit of claim 12, wherein a number of each first positive pin, first negative pin, second positive pin, second negative pin, and current output pin is more than one.

17. The voltage conversion circuit of claim 12, wherein the plurality of the first positive pins are shorted, the plurality of the first negative pins are shorted, the plurality of the second positive pins are shorted, the plurality of the second negative pins are shorted, and the plurality of the current output pins are shorted.

18. The voltage conversion circuit of claim 10, wherein the voltage conversion uses DC-DC conversion and is package by ball grid array.
